(19) United States
(12) Patent Application Publication
(10) Pub. No.: US 2012/0160916 A1
(43) Pub. Date: Jun. 28, 2012

(54) READ HEAD

(76) Inventors: Timo GALM, Mudau (DE); Thomas Freund, Mannheim (DE)

(21) Appl. No.: 13/327,163

(22) Filed: Dec. 15, 2011

Related U.S. Application Data
(60) Provisional application No. 61/423,912, filed on Dec. 16, 2010.

(51) Int. Cl. G06K 7/01

(52) U.S. Cl. 235/439

(57) ABSTRACT

A read head with a sensor unit is provided, whereby the sensor unit has a first RFID transponder reader unit and an induction detector unit, and the read head has a longitudinal axis and can be moved along the longitudinal axis of a track, and an evaluation unit connected to the RFID transponder reader unit and to the induction detector unit is provided. The RFID transponder reader unit is set up for absolute position determination and outputs a first position value, and the induction detector unit is set up for absolute position determination and outputs a second position value, and whereby the evaluation unit is set up to determine an absolute position from the first position value and the second position value.

This nonprovisional application claims priority to U.S. Provisional Application No. 61,423,912, which was filed on Dec. 16, 2010, and which is herein incorporated by reference.

### BACKGROUND OF THE INVENTION

1. Field of the Invention

The invention relates to a read head and a method for determining an absolute position.

2. Description of the Background Art

A read head is disclosed, for example, in German Offenlegungsschrift No. DE 10 2006 004 938 A1 as part of a described position determining system and is used for determining the position of a motor vehicle. RFID transponders are used as transducers for the read head. Another read head is known from WO 2008/101702, which corresponds to US 2010/0141244. In this case, to determine the position of a rotating wheel by means of the read head, the induction of magnets arranged on the rotating wheel is determined. Another read head is known from the position determining system in the German Offenlegungsschrift No. DE 10 2008 044 739 A1, which corresponds to US 2010/0308803. In this case, the position of a first object relative to a second object is determined by means of an inductive displacement sensor. To this end, the read head or the sensor unit in the read head passes near a marking section realized as a transducer unit. Another device and method for determining the position are known from WO 2005/012840, which corresponds to U.S. Pat. No. 7,245,121. In this case, the induction brought about by permanent magnets in the sensor is evaluated in a read head by means of a sensor. In so doing, the sensor unit arranged on the read head is capable of determining the induction of several magnets simultaneously.

Another position determining system is disclosed in EP 0 472 028 A2. In this case, RFID tags are detected by means of an RFID read unit on a carrier device in order to bring about directional changes or stops of the carrier device. Furthermore, an inductively operating detector unit is used to detect a deviation from a preferential direction. Other systems are known from EP 1 577 188 A2, which corresponds to U.S. Pat. No. 7,426,424, and EP 1 770 373 A2, which corresponds to US 2007/074416, and from U.S 2002/0129508.

A drawback of the prior-art read heads is that the position cannot be determined immediately at each point in time and/or that the construction of a position determining system with use of conventional read heads in conjunction with the corresponding transducer units is cost-intensive during manufacture and use. The prior solutions are also not sufficient during use of conventional read heads in a positioning system in a rail vehicle, particularly when, for example, in the case of crane units in harbor areas several 100 m must be traversed by a crane. This also applies during use as a read head as a speed sensor in circles with diameters greater than several meters.

### SUMMARY OF THE INVENTION

It is therefore an object of the invention to provide a read head and a use for a read head, which in each case reduce the disadvantages of the state of the art.

According to an embodiment of the invention, a read head with a sensor unit is provided, whereby the sensor unit has a first RFID transponder reader unit and a first induction detector unit, and the read head has a longitudinal axis and can be moved along a track in the direction of the longitudinal axis, and an evaluation unit connected to the RFID transponder reader unit and to the first induction detector unit is provided, whereby the RFID transponder reader unit is set up for absolute position determination and outputs a first position value, and the first induction detector unit is set up for absolute position determination and outputs a second position value, and whereby the evaluation unit is set up to determine an absolute position from the first position value and the second position value.

According to another embodiment of the invention, a method for determining the absolute position is disclosed, having a read head with a sensor unit, whereby the sensor unit has a first RFID transponder reader unit and a first induction detector unit, and the read head has a longitudinal axis and can be moved along a track in the direction of the longitudinal axis, and an evaluation unit connected to the RFID transponder reader unit and to the first induction detector unit is provided, whereby for absolute position determination a first position value is output by the RFID transponder reader unit, and for absolute position determination a second position value is output by the first induction detector unit, and an absolute position is determined by the evaluation unit from the first position value and the second position value.

An advantage of the read head of the invention is that a very reliable and precise position determining system can be provided particularly in conjunction with a suitable transducer unit, which has at least one RFID transponder and a transducer subunit having a metallic material. Another advantage of the determination type is that the absolute position can be determined particularly immediately after the current supply is turned on without a displacement of the read head. To this end, both the first value and the second value are available immediately after the voltage supply for the evaluation unit is turned on, without a relative movement of the read head to the transducer unit having to be performed as in an incremental system and without having to resort to a stored value. Another advantage of a position determining system of this type is that by means of the combination of two different types of sensors in the read head or two types of transducers, the accuracy of the absolute position determination by means of the read head is increased, particularly also at distances greater than 10 m, preferably greater than 100 m, in that the absolute position data can be determined very precisely by means of the read head from a row arrangement of the individual transducer units. In this case, the position can be determined for each absolute position from a first value and a second value. Both values are each determined by means of an absolute position determination. As a result, the respective absolute position of the read head is made up of a first value and a second value. Preferably, the reader unit and the detector unit are formed on a line that runs substantially parallel to a longitudinal axis of the read head.

Tests by the applicant have shown that using RFID transponders as transducers opens up a simple and reliable possibility for providing the necessary data simply and reliably to the read head in the case of an inquiry. In this case, it is advantageous to use on the transducer side simple cost-effective passive RFID transponders, which do not have their own current supply. The RFID transponders preferably operate within the range of 125 KHz, most preferably within the range of 13.5 MHz, and obtain the necessary power from the field of the RFID transponder reader unit. HF RFID transponders as well, which operate backscatter-based within the range above 800 MHz, can also be used preferably. The individual RFID transponders have a unique identification, particularly position identification, by which a definite position can be assigned to the particular RFID transponders in the sensor unit. The RFID transponders can be programmed especially simply with a consecutive sequence of numbers and the sequence of numbers can be read by the read head. If in a first embodiment the distance between two successive RFID transponders is known, an absolute position can be easily determined by the RFID transponder reader unit and in addition at least one other absolute position of the sensor unit in reference to the RFID transponder can be determined by means of the induction detector unit by a change in induction in the vicinity of the transducer subunit having a metallic material, for example, by induction of eddy currents in the metallic material; i.e., a high-resolution absolute position can be determined from a combination of RFID transponder data and the change in induction caused by a transducer subunit having a metallic material. It is understood that metallic materials are to be preferred that cause an especially strong induction in a magnetic field. In another embodiment, the identification of the particular transponder immediately contains its absolute position on the track, so that the first value is read without calculations directly from the RFID transponder.

As during use of a read head of this type in a position determining system, the data of the transducer unit can be determined without contact and without optical aids, the read head or the system is robust and not sensitive to soiling. Furthermore, it is advantageous, particularly for use in security-related systems, that in each position in which an RFID transponder can be read, the absolute position of the reader unit can be determined without a reference point having to be approached or the last position having to be stored. This is an advantage particularly during a power outage in that an absolute position can be readily determined.

In an embodiment, the evaluation unit is configured to determine the coarse resolution of the absolute position based on the first position value and the fine resolution of the absolute position based on the second position value.

In an embodiment, the evaluation unit is configured to determine the absolute position from the currently output first position value and the currently output second position value. To this end, in the case of the displacement the detection of the position values or position data occurs continuously. As a result, the particular position can be determined at any time at all points during a displacement. The evaluation unit is preferably set up to determine the coarse resolution of the absolute position based on the first position value and the fine resolution of the absolute position based on the second position value.

In another refinement, the sensor unit of the read head comprises in addition a second RFID transponder reader unit. In a suitable arrangement, the reader unit can read the data of two RFID transponders, as a result of which the security and accuracy during the position determination increase. Tests by the applicant have shown that it is advantageous to arrange the induction detector unit between the first and second RFID transponder reader unit within the sensor unit of the read head. The sensor unit can be used especially advantageously in security-related systems owing to the redundancy of the sensors arranged on the sensor unit. If, for example, namely the induction detector unit fails, the position, albeit if need be with a lower accuracy, can continue to be determined absolutely and reliably with use of one or both RFID transponder reader units.

In another embodiment, it is advantageous to arrange a plurality of induction detector units between the first and second RFID transponder reader unit. According to another preferred refinement, it is advantageous to provide within a read head an alternating arrangement of a plurality of RFID transponder reader units and a plurality of induction detector units and that the length of the read head has at least the length of a transducer unit, having at least one transducer subunit, which has a metallic material and is arranged between a first RFID transponder and a second RFID transponder.

It is clear that in the direction of the transducer units arranged, for example, on a track, the sensor unit preferably has a longitudinal axis which is configured substantially parallel to the longitudinal direction of the track. Further, the reader unit and the detector unit, i.e., the induction detector unit, are arranged on a line that is configured substantially parallel to the longitudinal axis.

According to another embodiment, the read head has the same number of induction detector units, located between two successive RFID transponder reader units, as transducer subunits having a metallic material arranged between two successive RFID transponders in the case of the transducer unit. As a result, the data from an individual transducer unit can be completely detected by the read head, without the read head having to be moved relative to the transducer unit to detect the data.

In connection with a row arrangement of a plurality of transducer units and the design of an alternating arrangement of RFID transponders and the transducer subunits having the metallic material, an absolute position determining system can be constructed for a precise determination of the absolute position, also in the case of lengths of several 100 m. It is preferred in this case to arrange the transducer units on a track, whereby an RFID transponder each is configured at the end and beginning of the track. Tests by the applicant have shown that in the case of transducer units arranged on a strip, the strip with the transducer units can be attached cost-effectively and continuously to a track, for example, by a gluing process. If the read head is arranged on a vehicle, particularly a rail vehicle, the position of the rail vehicle can be determined simply and reliably. The term rail vehicle covers all positively guided systems, regardless of their geometric configuration. Tests by the applicant have shown in particular that the read head of the invention can be used also in positioning systems in the case of circles with a diameter greater than several meters.

In another embodiment, the evaluation unit comprises evaluation electronics for outputting the position using data detected by a transducer unit. It is preferred, furthermore, to arrange the evaluation electronics on a plate above the sensor units. It is preferred, further, that the sensor unit of the read head has such a length that at each position of the read head both the first values of at least one RFID transponder and the second values can be determined by means of the induction data of the induction detector unit, caused by the change in the induction of an emitted magnetic field, when eddy currents are induced in the metallic material made as a part of the transducer unit.

In an embodiment, the metallic material of the transducer unit can also be made as a permanent magnet. As a result, the emission of a variable magnetic field by the induction detector unit is unnecessary. Instead, a Hall sensor is used as an induction detector unit for detecting the magnetic field.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a top view of a first embodiment of a row arrangement of a plurality of transducer units;

FIG. 2a is a top view of a first embodiment of a read head;

FIG. 2b is a top view of an alternative embodiment of a read head;

FIG. 3 is a side view of a position determining system of the invention;

FIG. 4 is a top view of a second embodiment of a row arrangement of a plurality of transducer units; and

FIG. 5 is a top view of a second embodiment of a read head.

### DETAILED DESCRIPTION

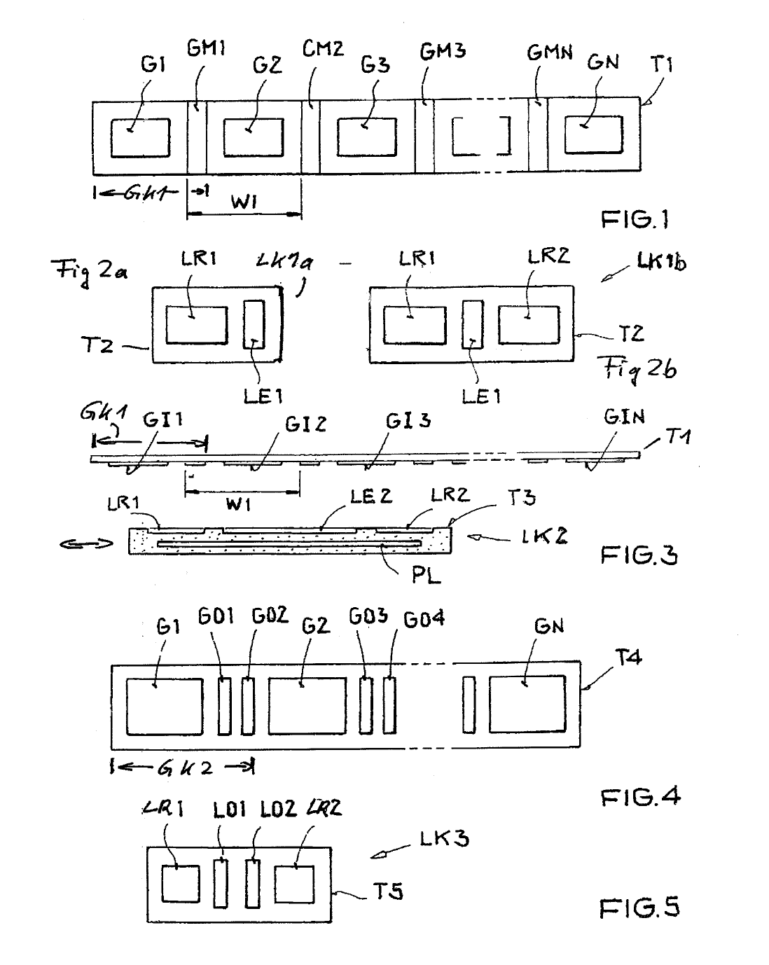

The illustration in FIG. 1 shows a top view of a first schematic embodiment of a row arrangement of transducer units arranged on a first support T1. The first support T1 is formed preferably as a flexible strip which preferably can be unrolled from a roll. A first transducer unit GK1 has an RFID transponder G1 and a transducer subunit GM1 having a metallic material. Accordingly, the successive transducer units comprise an RFID transponder G2 and transducer subunit GM2 having a metallic material or an RFID transponder G3 and transducer subunit GM3 having a metallic material, and the last transducer unit an RFID transponder GMN-1 and transducer subunit GMN-1 having a metallic material. The row arrangement of transducer units, which represents an alternating arrangement of RFID transponders and metallic materials, is ended by an RFID transponder GN. The length of a transducer unit is W1 and simultaneously represents the degree of repetition in the row arrangement of transducer units. So that the degree of repetition does not vary if possible from transducer unit to transducer unit and the accuracy of the position determination is not negatively affected, the strip is to be made as little expandable as possible in the longitudinal direction.

The illustration in FIG. 2a shows a top view of a schematic embodiment of a read head with a sensor unit LK1a. The sensor unit LK1a comprises a first RFID transponder reader unit LR1 and a first induction detector unit LE1. Further, the reader units are arranged on a component support T2.

The illustration in FIG. 2b shows a top view of a schematic alternative embodiment of a read head with a sensor unit LK1b. The sensor unit LK1b comprises the first RFID transponder reader unit LR1, the first induction detector unit LE1, and a second RFID transponder sensor unit LR2.

The illustration in FIG. 3 shows a schematic side view of a position determining system of the invention, having a row arrangement of transducer units, as already explained in relation to the drawing documents depicted in FIG. 1, and a read head with a second sensor unit LK2 with the first RFID transponder reader unit LR1 and a first induction detector unit LE2 and the second RFID transponder reader unit LR2 arranged on a component support T3. Further, the sensor unit LK2 comprises a plate PL, likewise arranged on the component support T3, for accommodating evaluation electronics. The distance of the sensor unit LK2 to the transducer units, arranged on the top side of the first support T1, is selected in such a way that the data of the RFID transponder and the change in induction due to the metallic material are reliably detected. The distance is preferably within the range of a few millimeters to a few centimeters. Further, the sensor unit LK2 can be shifted relative to the row arrangement of the transducer units.

The illustration in FIG. 4 shows a top view of a second schematic embodiment of a row arrangement of transducer units which are formed on a support T4. Hereafter, only the differences in regard to the first embodiment, explained in relation to the description of the illustration in FIG. 1, will be described. Accordingly, a transducer unit GK2 comprises the transponder G1 and two successive regions each with a transducer subunit GO1 and GO2 having a metallic material. The distances between the transducer subunits having a metallic material are selected in such a way that the sensor unit can achieve a best possible spatial resolution.

A top view of a second schematic embodiment of a read head with a third sensor unit LK3, arranged on a component support T5, is shown in the illustration in FIG. 5. Hereafter, only the differences in regard to the first embodiment, explained in relation to the description of the illustration in FIG. 2, will be described. Accordingly, the third sensor unit LK3 comprises a first induction detector unit LO1 and a second induction detector unit LO2. Both induction detector units LO1 and LO2 are configured between the two RFID transponder reader units LR1 and LR2. The arrangement of the two induction detector units LO1 and LO2 is adapted particularly to the second embodiment of a transducer unit, shown in FIG. 4, to detect the two transducer subunits having a metallic material arranged between the RFID transponders.

Further, the third sensor unit LK3 can also be used for the embodiment of a transducer unit with only one transducer subunit having a metallic material and arranged between two RFID transponders. Likewise, the sensor unit LK2 or LK1A, LK1B can also be used for the transducer unit, explained in relation to the drawing documents of FIG. 4.

It is understood that a rectangular design is preferred for the geometric design of the read head and the sensor unit; in said design, the reader unit and the detector unit are arranged on a line that is formed substantially parallel to the longitudinal axis of the read head. The longitudinal axis again points in the direction of the row of transducer units.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A read head having a longitudinal axis and is adapted to be moved along a track in a direction of the longitudinal axis, the read head comprising:
a sensor unit having a first RFID transponder reader unit and a first induction detector unit, the RFID transponder reader unit being set up for absolute position determination and outputting a first position value, the first induction detector unit being set up for absolute position determination and outputting a second position value; and
an evaluation unit connectable to the first RFID transponder reader unit and to the first induction detector unit, the evaluation unit being configured to determine an absolute position based on the first position value and the second position value.

2. The read head according to claim 1, wherein the evaluation unit is configured to determine the absolute position from the currently output first position value and the currently output second position value.

3. The read head according to claim 1, wherein the evaluation unit is configured to determine a coarse resolution of the absolute position based on the first position value and a fine resolution of the absolute position based on the second position value.

4. The read head according to claim 1, wherein the reader unit and the first induction detector unit are arranged on a line that runs substantially parallel to the longitudinal axis.

5. The read head according to claim 1, wherein the sensor unit comprises a second RFID transponder reader unit.

6. The read head according to claim 5, wherein the induction detector unit is arranged between the first and second RFID transponder reader unit.

7. The read head according to claim 5, wherein a second induction detector unit is arranged between the first and second RFID transponder reader unit.

8. The read head according to claim 5, wherein the read head has an alternating arrangement of a plurality of RFID transponder reader units and a plurality of induction detector units.

9. The read head according to claim 1, wherein a length of the read head has at least a length of a transducer unit, including at least one transducer subunit, which has a first metallic material and is arranged between a first RFID transponder and a second RFID transponder.

10. The read head according to claim 1, wherein the read head has the same number of induction detector units located between two successive RFID transponder reader units as metallic materials arranged between two successive RFID transponders in the case of a transducer unit.

11. The read head according to claim 1, wherein the sensor unit is mounted on a vehicle.

12. A method for determining an absolute position, the method comprising:
providing a read head with a sensor unit, the sensor unit having a first RFID transponder reader unit and a first induction detector unit, the read head having a longitudinal axis and is movable along a track in a direction of the longitudinal axis;
providing an evaluation unit that is connected to the RFID transponder reader unit and to the first induction detector unit;
outputting, for absolute position determination, a first position value by the RFID transponder reader unit;
outputting, for absolute position determination, a second position value by the first induction detector unit; and
determining an absolute position via the evaluation unit based on the first position value and the second position value.
